(19) United States
(12) Patent Application Publication
(10) Pub. No.: US 2015/0259542 A1
(43) Pub. Date: Sep. 17, 2015

(54) COPPER-BASED ANTIFOULING COMPOSITION

(71) Applicant: Ronald R. Savin, Ranco Mirage, CA (US)

(72) Inventor: Ronald R. Savin, Ranco Mirage, CA (US)

(21) Appl. No.: 14/432,097

(22) PCT Filed: Sep. 30, 2013
(86) PCT No.: PCT/US2013/062645

§ 371 Date: Mar. 27, 2015

Related U.S. Application Data
(60) Provisional application No. 61/708,834, filed on Oct. 2, 2012.
(60) Provisional application No. 61/842,764, filed on Jul. 3, 2013.

(51) Int. Cl. C09D 5/16; B05D 3/12; B05D 7/14; B65D 83/14

(52) U.S. Cl. CPC C09D 5/1618; B65D 83/75; C09D 5/1662; B05D 3/12; B05D 7/14

(57) ABSTRACT

An anti-fouling composition contains from 55-80% by weight copper flake or cuprous oxide, 10-30% by weight of a high molecular weight water resistant acrylic resin, and 0.5-5% by weight fumed silica and/or fluorinated resin. Most compositions are non-ablative. Copper flake of a particle size 15-25 microns is preferred for most applications. Some of the compositions are particularly useful for providing protection against fouling for boat propellers.

### CROSS REFERENCE APPLICATIONS

The present application claims priority from U.S. provisional applications 61/708,834 filed on Oct. 2, 2012 and 61/842,764 filed on Jul. 3, 2013, the contents of both of which are incorporated herein by reference.

### FIELD OF THE INVENTION

The present invention relates to copper-containing marine antifouling compositions. Particular embodiments relate to non-ablative coatings and to compositions that can be used to prevent fouling of ship or boat propellers.

### BACKGROUND OF THE INVENTION

Use of copper sheathing for reducing the fouling of ship's bottoms became established practice in the British navy in the eighteenth century and use later expanded to civilian shipping and gave rise to the term “copper bottomed”. The technique remained standard until wood was replaced by steel as the primary material for ship construction. The need to prevent fouling on such ships where copper metal could not be used as a result of the galvanic current generated when copper and steel are placed in proximity led to the development of antifouling paints.

Such anti-fouling paints typically included biocides such as organotin compounds and copper oxide. Other types of antifouling treatment include use of use of polymers to produce highly smooth surfaces to prevent adhesion of marine life. The use of biocide-based antifouling compositions is, however, troubling since they release toxic chemicals into the environment and can have adverse consequences well away from the surface to which they are applied and in 2001 some of the organotin-based compositions were banned from use by the International Maritime Organization for this reason. More recently interest in use of copper (typically cuprous) compounds has again revived. Such compositions are typically ablative.

It is estimated that there are as many as 20 million small boats made of fiber glass, wood, aluminum and tens of thousands of larger metal vessels, military, container ships, oil tankers, cruise ships etc. etc. that are painted and repainted often on a yearly basis.

U.S. Pat. Nos. 4,197,233 and 4,323,599 (David W. Marshall, assigned to Kennecott Corporation, issued Apr. 8, 1980 and Apr. 6, 1982 respectively) describe the use of copper flake treated to remove oxides and other contaminants from its surface and incorporated into an uncured water-insoluble polymer for application to a marine structure such as a boat hull. The coating exhibits outstanding anti-fouling properties. The cleaned copper flake is preferably incorporated into a water insoluble polymer such as an uncured epoxy resin modified by reaction with a polyol, which composition is cured by reaction with a curing agent such as an amine. Because the copper is embedded in the epoxy resin, such coatings require regular sanding to maintain their efficacy.

A commercial product sold under the tradename “Coppercoat” uses copper powder in combination with an epoxy and an epoxy hardener to apply antifouling coatings. As noted above, however, epoxy based coatings require regular sanding to maintain efficacy and electrical conductivity of the copper.

Prevention of fouling of propellers presents particular challenges. As described in an article by Kevin Koenig in Power Boat and Yacht this is a particular problem for boats that are used infrequently because high speed rotation of the propeller in water tends to remove fouling by frictional force, but if the propeller remains static for a period of time, fouling can build up and severely impact performance. The article describes sand blasting followed by an epoxy coating followed by a cuprous oxide coating as a way to prevent propeller fouling. The article implies that the compositions described are ablative, stating that the antifouling effect is the result of the copper compound seeping out slowly.

### SUMMARY OF THE INVENTION

In a first aspect, the present invention provides an anti-fouling composition that produces a non-ablative coating, the composition containing typically contain from 55-80% by weight copper flake, 10-25% % by weight of an acrylic resin, 0-20% glass or plastic hollow microspheres and 0.5-5% fumed silica and/or fluorinated resin.

In a second aspect, the invention provides a modification of this composition in which rosin is incorporated into the binder to render the coating ablative and the acrylic resin is optionally replaced by a vinyl resin.

In a third aspect, the present invention provides a non-ablative copper-based composition for use in providing antifouling protection for propellers. The composition typically comprises from 55-80% by weight copper flake or cuprous oxide, 10-30% by weight of a high molecular weight water resistant acrylic resin, and 0.5-5% fumed silica and/or fluorinated resin.

There is increasing concern about the use of ablative compositions which release toxic cuprous oxide into the environment and at present their use is restricted in California, Denmark and Sweden. Non-ablative compositions are therefore of increasing interest but need also remains for ablative compositions having improved corrosion resistance.

Copper flake is the preferred copper source in all aspects of the invention, but as noted above when the composition is intended for use in coating propellers may be partially or wholly replaced by cuprous oxide.

The hollow microspheres provide an effective low cost deep deposition of the coating that impressively reduces the high cost of the copper content by increasing the volume. Such spheres are typically employed in compositions for coating boat or ship hulls or to static structures that are not subject to the high shear to which coatings on propellers are subjected hen in use.

The fumed silica when milled with the other ingredients provides a nano technology pigment effectively preventing the coating from serious sedimentation. The fluorinated resin (such as poly tetrafluoroethylene [PTFE]) is effective in improving the release of fouling when combined with the other ingredients

Because copper is electroconductive, a primer layer of a dielectric material should be applied first to any metal propeller to prevent the creation of a galvanic current that could result in erosion and dissolution of the copper-containing coat.

The invention also provides a method for forming an antifouling composition on a boat or ship or a boat or ship propeller by first preparing the surface of the boat, ship or propeller to improve adhesion of coatings to it, for example by sand blasting or etching, then applying a coating of dielectric primer and then applying a non-ablative coating comprising copper flake or cuprous oxide.

For use, such compositions in all aspects of the invention may be thinned with an organic solvent such as methyl ethyl ketone, Xylol, Toluol or a combination of these solvents. Typically, the solvent will be mixed with the copper-containing composition in a weight ratio of from about 1:1 to 2:1.

Compositions according to the invention, especially those designed primarily for coating propellers, may be formulated for aerosol use for ease in spray application. When formulated for aerosol use, such compositions will be packaged in an aerosol can and additionally contain from 15 to 30% based on the copper and/or cuprous oxide/acrylic/silica and/or fluorinated resin composition of a propellent such as propane, n-butane or iso-butane, and mixtures of these, although other volatile compounds such as dimethyl ether may be used. Alternatively, the propellant may be present in a separate compartment in the container. Many of these are flammable and so care should be taken in their use to avoid exposure to flames or heat.

### DETAILED DESCRIPTION OF THE INVENTION

Unlike conventional cuprous oxide copper flake is non-toxic. Copper is also essential to human health. The copper flake used in the compositions of the present invention is of a high purity to ensure high conductivity. Copper flake used typically has a particle size of 15 to 25 microns, and an aspect ratio of 7 to 20, preferably 10. For example, copper milled to a particle length of 20 microns and a thickness of 0.5 microns may be used. A suitable copper flake is HyperCopper supplied by HYPERSEAL INC of California which is over 99.9% pure and extremely conductive. An important feature of this development concerning its effectiveness in contact with saltwater, an electrolyte.

Copper flake typically makes up from 55-80% by weight of the dry composition, more preferably 65-75, for example about 70% by weight of the dry composition.

As noted above, however, as long as it is not released into the environment and is incorporated into a non-ablative coating, cuprous oxide can be an effective component of compositions of the present invention designed for providing antifouling coatings for propellers.

Most commonly the compositions of the present invention employ acrylic resins as their film-forming component. Acrylic resins for use in the compositions of the present invention include very high molecular weight water-resistant acrylics. Suitable acrylics include BR 121 and BR 143 available from Dianal. Typically the suitable acrylic resins have number average molecular weight in excess of 60,000, for example 80,000-100,000. When used herein the term “acrylic resin” includes polymers wherein the repeating unit may be an acrylic or methacrylic unit. Other acrylics which may be suitable for coating boat or ship hulls but which are of less use for propellers include Avanse MV available from Dow Chemical.

In applications where an ablative coating is desired, a rosin may be incorporated into the coating, such as PDM Rosin obtainable from PDM Inc

In certain applications where rosin is present, the acrylic may be replaced by a vinyl film former such as vinyl chloride/vinyl acetate copolymers for example Vinnol copolymers supplied by Wacker or VAGH.resins.

Use of an acrylic resin permits application by way of spraying which cannot be carried out with epoxy based compositions such as Coppercoat. Furthermore, acrylic based compositions can if necessary be removed by use of solvents such as methyl ethyl ketone, xylol or toluol.

The film forming resin such as an acrylic resin typically constitutes from 10-25% by weight of the dry composition preferably 15-20%, for example about 17.5% by weight.

In compositions that are intended to ablate and so contain rosin, the rosin is present in an amount of from 10-50% of the film forming resin or 1-7%, preferably 2-5%, for example about 3% by weight of the total composition. Before any thinning occurs.

Fluorinated polymer particles that may be used in the compositions of the invention typically have a particle size of less than 150 mesh, preferably less than 200 mesh, for example less than 300 mesh. A suitable polyfluorinated resin is Teflon®, obtainable from E. I. DuPont de Nemours Inc. of Wilmington, Del. Another suitable polyfluorinated resin is 807 PTFE supplied by Shamrock.

The fumed silica when milled with the other ingredients provides a nano technology pigment effectively preventing the coating from serious sedimentation. The fluorinated resin (such as poly tetrafluoroethylene [PTFE]) is effective in improving the release of fouling when combined with the other ingredients

Hollow glass or plastic particles for use in the compositions of the present invention other than those intended for use on propellers, for example those intended for application to boat or ship hulls, are typically of a particle size of less than 100 U.S. mesh (149 microns) more preferably from 3 to 50 microns. Conveniently, some or all of the particles may be obtained from crushed recycled glass or waste fiberglass. I have found that glass spheres of a mean particle size of 1 to 50 microns, more preferably 15 to 40 microns are useful in the compositions of the invention. Suitable glasses include Sphericell® hollow glass spheres obtainable from Potters Industries Inc of Valley Forge Pa. and recycled low alkali fiber glass particles obtainable from Vitro Minerals of Social Circle Georgia. Particularly suitable glasses include Potter's 60 s grade microspheres and Vitro Minerals grade LA400. Such materials can also be used in mixtures with each other, for example from 30:70 to 70:30 by weight.

Hollow glass or plastic microspheres reduce the density of the composition and its material cost and facilitate application. Typically when present they make up from 5-20% of the composition, preferably from 5-15%, for example 6 to 10% by weight of the composition.

In preparing compositions of the invention, the copper flake or, in compositions for application to propellers where it is of use, cuprous oxide is mixed dry with the other components and milled into a powder coating composition.

The powder coating is milled dry with all of the materials combined to a tap density greater than 17 lbs/gal, for example of approximately 21 lbs/gal.

The composition can be transported dry and thinned at the application site and with a ratio of approximately one part by weight of powder to one to two parts by weight of MEK, Xylol, Toluol or a combination of these solvents. I have found that a tertiary butyl acetate:acetone mixture is particularly useful. Such a composition may typically have a weight ratio of t-butyl acetate to acetone of about 3:1 and may be used in a ratio of about 1:1 of powder to butyl acetate/acetone mixture. Alternatively, as described above, the composition may be formulated for aerosol application in which such thinners may be used.

Sprayable formulations of the present invention which may be of particular use in oating relatively small items such as a boat propeller may be packaged in an aerosol spray canister in amounts of from 12 to 24 ounces per canister. Such compositions may be used in either a conventional canister in which propellant is mixed with the material to be sprayed, but can also be used in systems wherein the propellant and sprayable composition are kept separate, for example in a piston barrier system or a bag in can system. Such canisters will also contain from 15-30%, for example about 20% of the total composition of propellent, normally, propane, n-butane or isobutane.

The precise composition employed in any situation will depend upon the nature of the substrate, the degree of durability and to some extent on the esthetics required.

Other components that may be included depending on the intended use of the composition can include suspension agents, for example cellulosic suspension agents such as hydroxyethylcellulose, antifoam agents such as ByK 024 and Elementis DF 71210 and agents having specialized biocidal properties such as mildewicides. Other useful components may include dispersing agents such as W-28, available from Elementis, glycol esters such as Dowanol DNP, available from Dow Chemical, codispersants such as primary amino alcohol co-dispersant, for example AMP-95, available from Angus, ethylene glycol, and aluminum silicate, available from Kish.

The compositions of the invention may be used to prevent fouling on a variety of surfaces that come into contact with salt or fresh water, including boat hulls, boat propellers, and marine structures such as jetties and the like. Such structures are commonly made of metal, such as steel, galvanized metal or fiber glass. To be effective on metal substrates, a nonmetallic primer is required as copper flake is extremely conductive and is not effective when in contact with bare metal or a conductive primer, i.e. zinc rich primers, consequently a protective primer that is non-conductive must be applied to prevent electrolysis. Suitable dielectric primers include those discussed below in the particular context of coating propellers. An acrylic emulsion primer resistant to saltwater that provides long term resistance to saltwater immersion may be used for this purpose.

In view of the high demands on coatings on propellers, it may be desirable to take particular steps to improve the adhesion of the coating to the propeller. Prior to application of any coating composition, the propeller may be removed from the boat. The surface of the propellers should be treated to improve adhesion. A preferred treatment is sand blasting to provide a profile of 50-75 microns. A dielectric primer is then applied over the roughened surface. Such primer should not contain any conductive components (for example primers containing zinc should be avoided. Suitable primers include acrylic resin-based compositions which may also include components such as fumed silica, titania, barium sulfate (baryte) and non-conductive pigment, although other dielectric resins that provide good adherence to an acrylic top coat may also be used.

The dielectric primer can be applied in any convenient manner, for example by brushing or spraying, including spraying as an aerosol. Typically, the dielectric primer will be applied to a thickness of from 2.25 to 5 mils, preferably 3 to 4 mils.

After application of the dielectric primer, the solvent used for its application will be allowed to evaporate before applying the copper-containing top coat. For example for application of the copper-containing top coat will typically take place an hour or more after the primer has been applied.

The copper flake or cuprous oxide-containing coating described above will then be applied. Typically this will be applied to a thickness of from 2.25 to 5 mils, preferably of from 3 to 4 mils. The composition may be applied in any convenient way including by brushing or spraying. If spraying is employed, this may conveniently be effected by use of an aerosol spray of the type described above.

Before re-mounting on a boat and/or use, solvent used in application of the coatings should be allowed to evaporate, for example for a period of 48 hours or more.

The invention is illustrated by the following examples.

### EXAMPLES

### Example 1

The following composition is a non-ablative anti-fouling composition suitable for use on boat or ship hulls or static structures.

The components are milled. (Pebble mill, attritor or extruder) to a fine powder

| LBS | Material | Supplier |
|---|---|---|
| 225 | BR121 or 143 acrylic | Dianal |
| 675 | Copper Flake | Hyperseal |
| 55 | #60 microspheres | Potters |
| 22 | 807 PTFE | Shamrock |
| 23 | EH-5 (fumed silica) | Cabot Corporation |

The binder is a very high molecular water resistant acrylic with superlative adhesion to fiberglass, galvanized zinc, stainless steel and virtually most substrates including powder coatings.

The dry powder is mixed at the application site by a weight ratio of one part of dry powder to one part of solvent (MEK, Toluol, Xylol or combination).

Test panels dozen panels of steel and fiberglass coated on one side with the above composition were exposed over a period of six months in the Salton Sea, approximately 50 miles from Palm Springs. It is a dead lake badly contaminated, approximately 5% salt. The Salton Sea is the runoff from the irrigation of adjacent farming, 50 miles on each side.

None of the copper flake pigmented acrylic has developed any fouling. The uncoated side became extremely fouled after a few weeks. The coated side of exposed panels began to form a protective oxide or a green “Statue of Liberty” color. After several more weeks the coated side begins to turn black caused by the nitrates in the wash off fertilizer forming copper nitrate which is black. The copper flake is totally waterproof or non-ablative.

Similar coated panels in Aruba and Gothenburg, Sweden exposed for several months with the coated side of the panels being free of fouling; the unprotected side is heavily fouled and encrusted with barnacles.

Examples 2-4 illustrate compositions that are of use in providing non-ablative anti-fouling coatings for propellers

### Example 2

### Copper Flake

The components are milled (Pebble mill, attritor or extruder) to a fine powder

| LBS | Material | Supplier |
|---|---|---|
| 244 | BR121 or 143 acrylic | Dianal |
| 732 | Copper Flake | Hyperseal |
| 24 | EH-5 (fumed silica) | Cabot Corporation |

### Example 3

### Cuprous Oxide

The components are milled (Pebble mill, attritor or extruder) to a fine powder.

| | | |
|---|---|---|
| 260 | BR 121or143 acrylic | Dianal |
| 715 | Cuprous oxide | Chemet |
| 25 | EH-5 (fumed silica) | Cabot Corporation |
| Total | 1000 | |

A suitable dielectric primer for use with this composition has the following composition:

| Lbs | Material | Supplier |
|---|---|---|
| 238 | BR 121-143 | Dianal |
| 595 | Barytes (KB-80) | Kish Company |
| 119 | TiO₂ | Kronox |
| 24 | Black Oxide | Prince Minerals |
| 24 | EH-S | Cabot Corporation |
| Total | 1000 | |

The binder is a very high molecular water resistant acrylic with superlative adhesion to fiberglass, galvanized zinc, stainless steel and virtually most substrates including powder coatings.

The dry powder is mixed at the application site by a weight ratio of one part of dry powder to one part of solvent (for example MEK, Toluol, Xylol, a combination of tert butyyl acetate and acetone (for example in a 2:1 ratio) or a mixture of such solvents).

### Example 4

The following are the two aerosol formulae may be used in for application of a dielectric primer coating and a copper containing topcoat.

| Component | % by Weight |
|---|---|
| Primer | |
| MEK {Methyl Ethyl Ketone | 22.3 |
| Acetone | 20.0 |
| Primer Component | 20.0 |
| Propane | 13.6 |
| N-Butane | 6.4 |
| N-Butyl Acetate | 5.5 |
| Ethyl Ester | 5.0 |
| PM Acetate | 0.8 |
| Ethyl Acetate | 0.5 |
| Aliphatic Petroleum Naphtha | 0.2 |
| Ethyl Alcohol (Ethanol) | 0.1 |
| Isopropyl Alcohol | 0.1 |
| Non Hazardous Ingredients | 5.7 |
| Topcoat | |
| Copper Compound | 24.7 |
| MEK (Methyl ethyl Ketone | 22.3 |
| Acetone | 20.0 |
| Propane | 13.6 |
| N-Butane | 6.4 |
| N-Butyl Acetate | 5.5 |
| Ethyl Ester | 5.0 |
| PM Acetate | 0.8 |
| Ethyl Acetate | 0.5 |
| Aliphatic petroleum Naphtha | 0.2 |
| Ethyl alcohol (Ethanol) | 0.1 |
| isopropyl alcohol | 0.1 |
| Non-Hazardous Ingredients | 1 |

A series of panels have been immersed in the highly contaminated Salton Sea in Southern California. Exposure over fiber glass, aluminum and steel during two years of test data have confirmed:
1. The uncoated side of fiber glass, steel and aluminum panels developed heavy barnacle and fouling within four months of exposure. The fiber glass panels coated with an elemental flaked copper acrylic (aerosol sprayed) exhibited neither arnacles, fouling nor slime after four months of exposure.
2. The Copper flake/acrylic over the unprimed steel and aluminum panels developed numerous small barnacles over the entire surface of the panels. The uncoated sides were deeply encrusted with barnacles after four months of exposure.
3. The steel and aluminum panels that had been aerosol coated or brushed with the dielectric primer and aerosol top-coated or brushed with the elemental copper flaked acrylic exhibited no fouling nor slime on the coated side.
   These tests confirm that:
1. That an aerosol or brush application with a non-conductive primer over steel or aluminum and brushed or aerosol top coated with a flaked elemental copper acrylic provides outstanding resistance to fouling.
2. When steel or aluminum surfaces are not protected with a dielectric primer, the elemental copperflake top coat develops small barnacles over its entire surface.

The following laboratory propeller tests were conducted to determine the quality of adhesion and resistance to: 1) Wear, 2) Cavitation, 3) Turbulence, when exposed in 10% saltwater.

Four small marine propellers were exposed in 10% saltwater in a five gallon container attached to the shaft of a high speed paint dispenser during a test period of 20 days. Two of the propellers were well sanded after physically removing all visible contamination and aerosol coated with a dielectric primer then top coated with a copper flaked acrylic. The other two propellers were sandblasted to a 50-75 micron profile and primed and top coated in the same manner as the two non-sandblasted propellers.

The four propellers were run 8 hours per day during the 20 day test period at approximately 2000 RPMs in a 10% saltwater solution to determine the quality of adhesion and potential wear of the copperflake top coat.

Each working day after 8 hours of agitation all four propellers were carefully inspected to determine the quality of adhesion and any wear based on:
1. Cleaning and sanding propellers; and
2. Sandblasting
The results are as follows:

The cleaned and sanded bronze propellers exhibited a loss of coating on the edges of the marine propellers after only 16 hours of agitation, however, there was little to no wear of the copper top coat. The two sandblasted bronze propellers after 120 hours at 2000 RPM agitation in 10% saltwater exhibited no loss of adhesion nor wear confirming that sandblasting over a 50-75 micron profile will prevent loss of adhesion and top coat wear.

The long term saltwater exposure to determine the quality of anti-fouling over steel and aluminum substrates in the Salton Sea confirmed that the metallic surface of the propeller must be primed prior to the application of a non-ablative cuprous oxide or a flaked elemental copper acrylic top coat.

The following suggested formulae will enable an experienced aerosol manufacturer to effectively package the acrylic primer and copperflake acrylic top coat. The formulae can also be brushed with a one to one by weight dilution of primer and top coat with xylol, toluol, MEK or with a 50% by weight of a 65% TBA-35% acetone dilution to achieve an exempt VOC status.

### Example 5

### vinyl-Based Ablative Composition

The following composition was milled to a fine powder:

| % By Weight | Material | Supplier |
|---|---|---|
| 18.3 | Vinnol | Wacker |
| 3.2 | PDM Rosin | PDM Inc |
| 75.3 | Copper flake | Hyperseal Inc |
| 3.2 | Silica EH-5 | Cabot Corporation |

### Example 6

### Acrylic-Based Ablative Composition

The following composition was milled to a fine powder:

| % By Weight | Material | Supplier |
|---|---|---|
| 18.3 | BR 143 | Dianal |
| 3.2 | PDM Rosin | PDM Inc |
| 75.3 | Copper flake | Hyperseal Inc |
| 3.2 | Silica EH-5 | Cabot Corporation |

The compositions of Examples 5 and 6 are typically reduced with methyl ethyl ketone or a mixture of methyl ethyl ketone and toluol (for example a 20:80 mixture) prior to use. Such materials are typically used in an amount equal to the weight of copper in the composition.

1. An anti-fouling composition comprising from 55-80% by weight copper flake or cuprous oxide, 10-30% by weight of a high molecular weight water resistant acrylic resin, and 0.5-5% by weight fumed silica and/or fluorinated resin.

2. A composition as claimed in claim 1, comprising 65-75 weight percent copper flake or cuprous oxide.

3. A composition as claimed in claim 1, comprising 15-20%, acrylic resin.

4. A composition as claimed in claim 1 comprising from 55-80% copper flake.

5. A composition as claimed in claim 4, wherein the copper flake has a particle size of from 15-25 microns.

6. A composition as claimed in claim 4, wherein the copper flake has an aspect ratio of from 7 to 20.

7. A composition as claimed in claim 1 further containing from 1-20% glass or plastic hollow microspheres, said hollow microspheres.

8. A composition as claimed claim 1 further comprising a propellant.

9. A composition for application to a surface comprising an antifouling composition as claimed in claim 1 further comprising a solvent selected from the group consisting of MEK, Xylol, Toluol or a combination in a weight ratio of solvent to antifouling composition of from about 1:1 to about 2:1.

10. A composition for application to a marine propeller comprising an antifouling composition as claimed in claim 1, and a mixture of tert. butyl acetate and acetone in a weight ratio of about 3:1.

11. A container fitted with a spray valve and actuator containing a propellant and a composition comprising from 55-80% by weight copper flake or cuprous oxide, 10-30% by weight of an acrylic resin, and 0.5-5% fumed silica and/or fluorinated resin.

12. A container as claimed in claim 11, wherein said propellant is propane, n-butane, isobutane or a mixture of two or more thereof and said propellant and said composition are mixed together.

13. A container as claimed in claim 12, wherein said propellant is propane, n-butane, isobutane or a mixture of two or more thereof and said propellant and said composition are located in separate compartments.

14. A method of applying an antifouling coat to a metallic marine structure, such as a marine propeller which comprises: roughening the surface to a profile of 50 to 75 microns;
applying a dielectric primer; and then
applying a copper flake or cuprous oxide-containing composition as claimed in claim 1.

15. A method as claimed in claim 14, wherein said dielectric primer is a high molecular weight acrylic resin-based primer.

16. An anti-fouling composition comprising from 55-80% by weight copper flake 10-30% by weight of a film-forming resin selected from high molecular weight water resistant acrylic resin and a vinyl resin, 1-7%, rosin and 0.5-5%—by weight fumed silica and/or fluorinated resin.

17. An antifouling composition as claimed in claim 16 comprising about 2-5% by weight resin.

18. A composition as claimed in claim 7 wherein said hollow microspheres have a particle size in the range about 2 to 100 microns.

19. A composition as claimed in claim 8 wherein the propellant is selected from the group consisting of propane, n-butane, isobutane and a mixture of two or more thereof.
